(19) United States
(12) Patent Application Publication
(10) Pub. No.: US 2008/0263125 A1
(43) Pub. Date: Oct. 23, 2008

(54) MOBILE STORE PRODUCT LOCATOR

(76) Inventor: Edward H. Nortrup, Stoneham, MA (US)

Correspondence Address: STRATEGIC PATENTS P.C.., C/O PORTFOLIOIP, P.O. BOX 52050, MINNEAPOLIS, MN, 55402, US

(21) Appl. No.: 11/971,879

(22) Filed: Jan. 9, 2008

Related U.S. Application Data
(60) Provisional application No. 60/884,229, filed on Jan. 10, 2007.

(51) Int. Cl. G06F 15/16

(52) U.S. Cl. 709/201

(57) ABSTRACT

An embodiment of the present invention involves a location based service, method, and/or system. The service, method, and/or system may involve accessing an internet using a mobile communication facility; assessing a location of the mobile communication facility; requesting product information; and delivering the product information to the mobile communication facility, wherein the product information includes information relating to a location within a store where the product can be found.

### CROSS-REFERENCE TO RELATED APPLICATIONS

This application claims the benefit of the following provisional application, which is hereby incorporated by reference in its entirety: U.S. provisional patent application Ser. No. 60/884,229, filed Jan. 10, 2007.

### BACKGROUND

1. Field

The present invention relates to a location based service accessed on a mobile communication facility.

2. Description of the Related Art

The proliferation of mobile communication devices has increased the accessibility of information for many. There exists, however, a real need for improved location based services.

### SUMMARY

An aspect of the present invention relates to a location based service adapted to facilitate product purchases from brick and mortar stores. In embodiments, the location based service may be accessed by a user of a mobile communication facility (e.g. a pda or cell phone) and the user may be provided with product location availability information based on the mobile communication facilities present location (e.g. through a gps calculated location).

### BRIEF DESCRIPTION OF THE FIGURES

The invention and the following detailed description of certain embodiments thereof may be understood by reference to the following figures:

FIG. 1 illustrates a location based service according to the principles of the present invention.

While the invention has been described in connection with certain preferred embodiments, other embodiments would be understood by one of ordinary skill in the art and are encompassed herein.

All documents referenced herein are hereby incorporated by reference.

### DETAILED DESCRIPTION

An aspect of the present invention relates to providing in-store product information to a mobile communication facility (e.g. a cell phone, pda, internet appliance, mobile phone, satellite phone). In embodiments, the mobile communication facility may access product information by accessing the internet or other network. In embodiments, the mobile communication facility may access product information by accessing a client side program resident on the mobile communication facility. The in-store product information may relate to the location of the product within the store, price of the product within the store, sale information relating to a product in the store, coupon information relating to a product in the store, or other information relating to a product in the store. In preferred embodiments, a user may access product information through a local search algorithm when the user is in or near a store of interest. The location of the mobile communication facility may be matched with a store (e.g. either one that is nearby, or one that the user is inside of) and in-store information relating to that store may be provided.

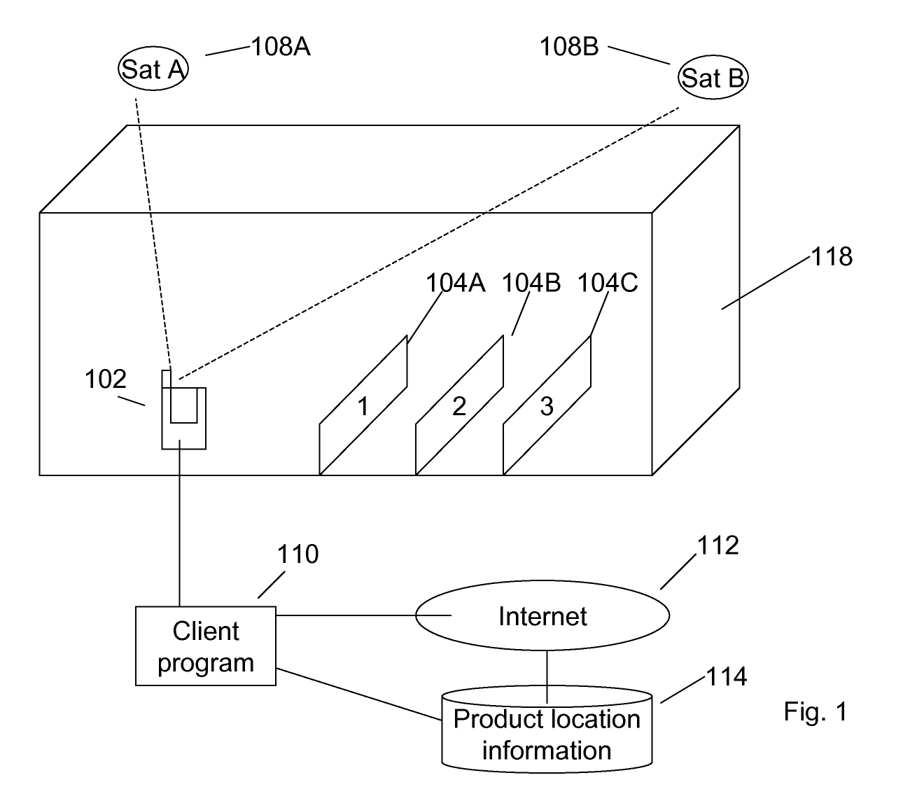

FIG. 1 illustrates a product location platform and environment (e.g. store 118) according to aspects of the present invention. In this embodiment, a user may operate a mobile communication facility 102, such as a mobile phone, pda or other mobile communication facility, and the user may enter a product information request on the mobile communication facility 102. For example, the user may enter a product name, product category, product reference number, information relating to a product, or the like into a query entry facility on the mobile communication facility. In certain embodiments, the mobile communication facility 102 may have a resident client application 110 and the client application 110 may be adapted to access product information either stored on the mobile communication facility 102 (e.g. in database 114) or it may be adapted to access product information stored remotely (e.g. in database 114), which may be accessible through a network (e.g. the Internet 112).

In embodiments, the client program 110 may be related to a particular store (e.g. Wal-Mart, Stop and Shop). The particular store program may be downloaded from a store website, for example, and loaded on the mobile communication facility. The store program may access product information locally on the mobile communication facility 102 when the product information is stored locally in a database 114 which is local. In other embodiments, the store client program may access product information in a database 114 accessible through the internet 112.

In embodiments, the client program 110 may be a web browser that is adapted to access product information database(s) 114 through the internet The client program may access a search program (such as Google, Yahoo!, Google Local or Yahoo! Local) and search requests entered into on the mobile communication facility may be processed through the search program. For example, a user may access a search program on his mobile communication facility 102 and submit a product related search query. The product related search query may then be processed through the search program to return relevant results. In embodiments, the search program may use a localization search algorithm (e.g. Google Local) and the product search query may include relevant mobile communication location information to assist in the identification of appropriate local product information. The local information may be entered manually or automatically. For example, the user may enter his location (e.g. address, town, state, zip code) or the mobile communication facility may use a gps system (e.g. using satellites 108) to assess its location.

In embodiments, the product information may include in-store information. For example, the in-store information may relate to the mobile communication facility's location. A user may be in or near a store 118 and he may enter a product name in the client program 110 (e.g. a browser application accessing a local search algorithm). A gps system associated with the mobile communication facility may assess the current location of the mobile communication facility and use this location information as part of the search query. The search program using a local search algorithm may then process the information and return in-store location information such as the aisle 104 and/or shelf where the product can be found within the store near the user's location. The user may be in Wal-Mart, for example, and want to look for a flashlight or other item, so he may type “flashlight” into the browser program. The browser program may search for the relevant information relating to the search term and it may consider the location of the mobile communication facility (e.g. as determined by a gps system or as determined by the user and manually entered) to determine the most relevant local information. The most relevant information may relate to the aisle, shelf, sale, coupon, or other related product information within the store.

While the invention has been described in connection with certain preferred embodiments, other embodiments may be understood by those of ordinary skill in the art and are encompassed herein. All document referenced herein are hereby incorporated by reference.

I claim:

1. A method, comprising:
accessing an internet using a mobile communication facility;
assessing a location of the mobile communication facility;
requesting product information; and
delivering the product information to the mobile communication facility, wherein the product information includes information relating to a location within a store where the product can be found.

2. The method of claim 1 wherein the step of accessing the internet involves accessing a store website.

3. The method of claim 1 wherein the step of accessing the internet involves accessing a search engine.

4. The method of claim 3 wherein the search engine is separate from a store's website.

5. The method of claim 3 wherein the search engine is a local search engine.

6. The method of claim 3 wherein the search engine uses a local search algorithm.

7. The method of claim 1 wherein the location within the store is a shelf location.

8. The method of claim 1 wherein the location of the mobile communication facility is automatically assessed.

9. The method of claim 8 wherein the automatic location is accomplished through triangulation.

10. The method of claim 9 wherein the triangulation is a local triangulation system.

11. The method of claim 8 wherein the automatic location is accomplished through a gps system.

12. The method of claim 1 wherein the location of the mobile communication facility is manually assessed.

13. A method, comprising:
accessing a mobile communication facility client program;
assessing a location of the mobile communication facility;
requesting product information; and
displaying the product information on the mobile communication facility, wherein the product information includes information relating to a location within a store where the product can be found.

14. The method of claim 13 wherein the client program accesses an internet to obtain the product information.
